(19) United States
(12) Patent Application Publication
(10) Pub. No.: US 2023/0288725 A1
(43) Pub. Date: Sep. 14, 2023

(54) Modular Eyeglasses Assembly

(71) Applicant: Sheila Egbuonye, Manor, TX (US)

(72) Inventor: Sheila Egbuonye, Manor, TX (US)

(21) Appl. No.: 17/694,092

(22) Filed: Mar. 14, 2022

(51) Int. Cl. G02C 1/08; G02C 5/02

(52) U.S. Cl. CPC G02C 1/08; G02C 5/02; G02C 2200/08

(57) ABSTRACT

A modular eyeglasses assembly includes a pair of corrective lenses prepared to conform to a predetermined optical prescription to correct visual deficiencies for a specific user. A plurality of eyeglass frames is provided and each of the eyeglass frames releasably engages a respective one of the corrective lenses for correcting the specific user's vision. Each of the eyeglass frames has a unique structure with respect to each other. A pair of temples has a temple grip is integrated into the temple and a nose bridge has a pair of bridge grips is integrated into the nose bridge. Each of the bridge grips and the temple grips releasably engages a respective one of the corrective lenses to facilitate the corrective lenses to be positioned for correcting the user's vision. A pair of rimless eyeglass frames is provided to releasably engage a respective one of the corrective lenses.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to eyeglasses devices and more particularly pertains to a new eyeglasses device for facilitating a user to wear corrective lenses in a variety of different ways. The device includes a pair of corrective lenses and a plurality of eyeglass frames that each includes a receiving element for releasably engaging the corrective lenses. In this way a selected pair of eyeglass frames can be worn for correcting a user's vision. A pair of temples and a nose bridge is provided and each of the temples and the nose bridge releasably engages the corrective lenses. In this way the corrective lenses can be worn in the convention of frameless eyeglasses. A pair of rimless eyeglass frames is provided which each has a receiving element for releasably engaging the corrective lenses. In this way the corrective lenses can be worn in a variety of manners to satisfy the user's preference.

(2) Description of Related Art Including Information Disclosed Under 37 CFR 1.97 and 1.98

The prior art relates to eyeglasses devices including a pair of eyeglasses that has a pair of hinged frame rims to facilitate the frame rims to be opened for removing lenses from the frame rims. The prior art discloses an eyeglass device that includes a pair of frame rims that can be opened for removing lenses from the frame rims. The prior art discloses a pair of eyeglasses that includes a brow bar and a coupling member, attached to a lens, that engages the brow bar. The prior art discloses a pair of eyeglasses that has an opening in each of a pair of frame rims for insertably receiving a lens. The prior art discloses a pair of eyeglass frames that have magnets and a pair of lenses that have magnets for magnetically retaining the lenses in the eyeglass frames. The prior art discloses a pair of eyeglass frames that include a first set of lenses that are permanently fixed in the eyeglass frames and a second set of lenses that are removably attachable to the eyeglass frames.

### BRIEF SUMMARY OF THE INVENTION

An embodiment of the disclosure meets the needs presented above by generally comprising a pair of corrective lenses prepared to conform to a predetermined optical prescription to correct visual deficiencies for a specific user. A plurality of eyeglass frames is provided and each of the eyeglass frames releasably engages a respective one of the corrective lenses for correcting the specific user's vision. Each of the eyeglass frames has a unique structure with respect to each other. A pair of temples has a temple grip is integrated into the temple and a nose bridge has a pair of bridge grips is integrated into the nose bridge. Each of the bridge grips and the temple grips releasably engages a respective one of the corrective lenses to facilitate the corrective lenses to be positioned for correcting the user's vision. A pair of rimless eyeglass frames is provided to releasably engage a respective one of the corrective lenses.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pair of corrective lenses of an embodiment of the disclosure.

FIG. 2 is a perspective view of a modular eyeglasses assembly according to an embodiment of the disclosure.

FIG. 3 is a back perspective view of a pair of eyeglass frames of an embodiment of the disclosure.

FIG. 4 is a rear perspective view of a pair of eyeglass frames of an embodiment of the disclosure.

FIG. 5 is a perspective view of a pair of eyeglass frames of an embodiment of the disclosure.

FIG. 6 is an exploded perspective view of a pair of temples and a nose bridge of an embodiment of the disclosure.

FIG. 7 is a front view of a pair of temples and a nose bridge of an embodiment of the disclosure.

FIG. 8 is a front exploded view of a pair of rimless eyeglasses of an embodiment of the disclosure.

FIG. 9 is a back exploded view of a pair of rimless eyeglasses of an embodiment of the disclosure.

FIG. 10 is a cross sectional view taken along line 10-10 of FIG. 2 of an embodiment of the disclosure.

### DETAILED DESCRIPTION OF THE INVENTION

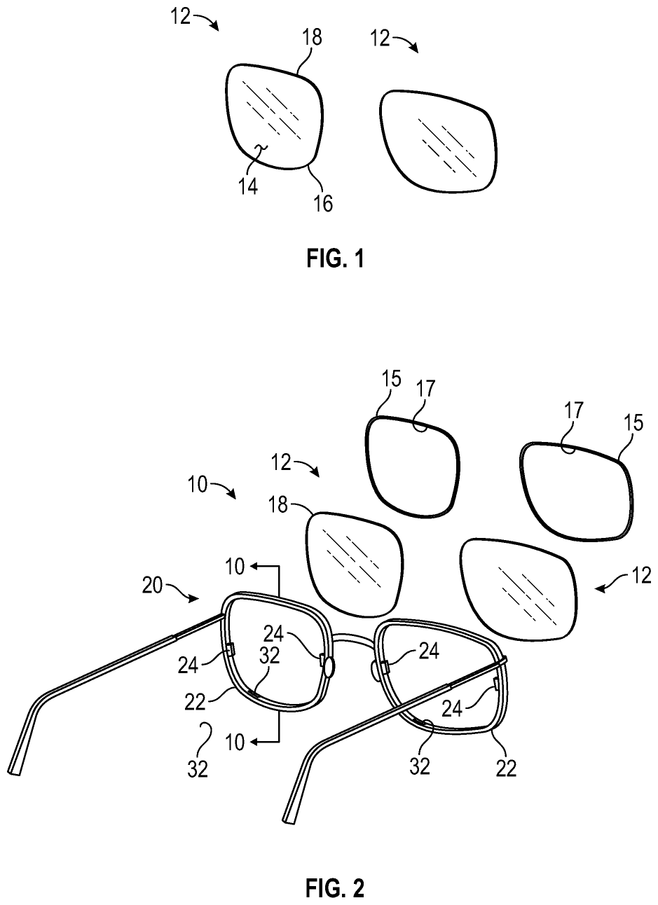

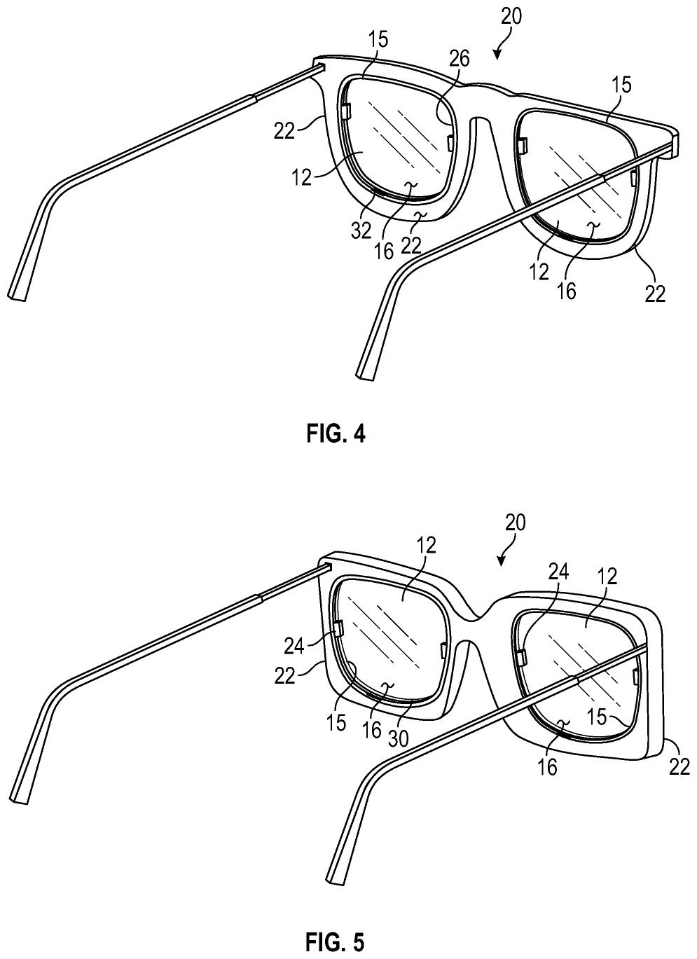

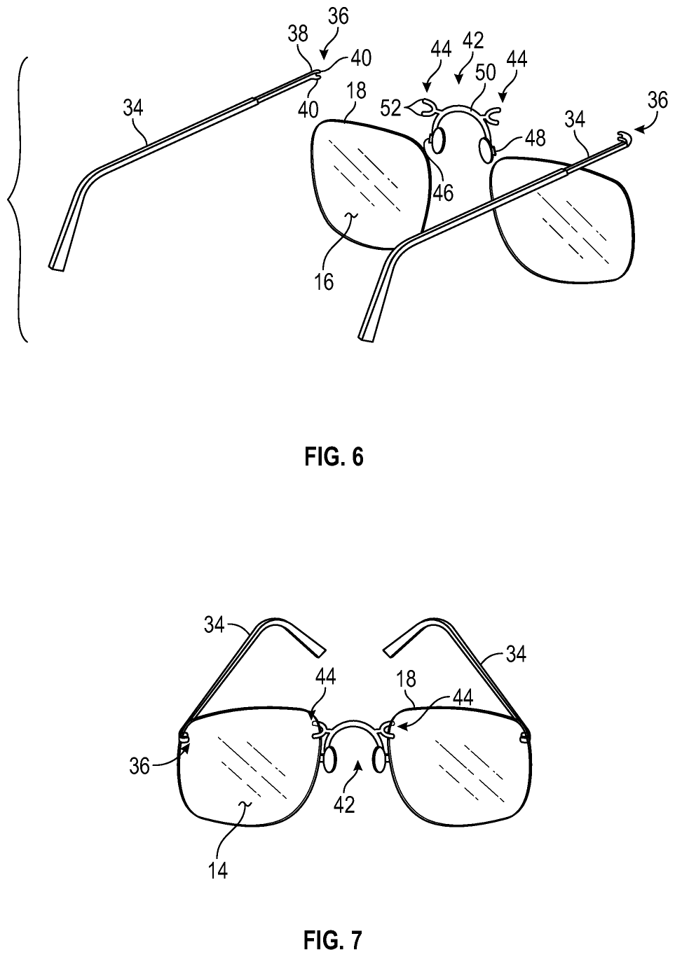

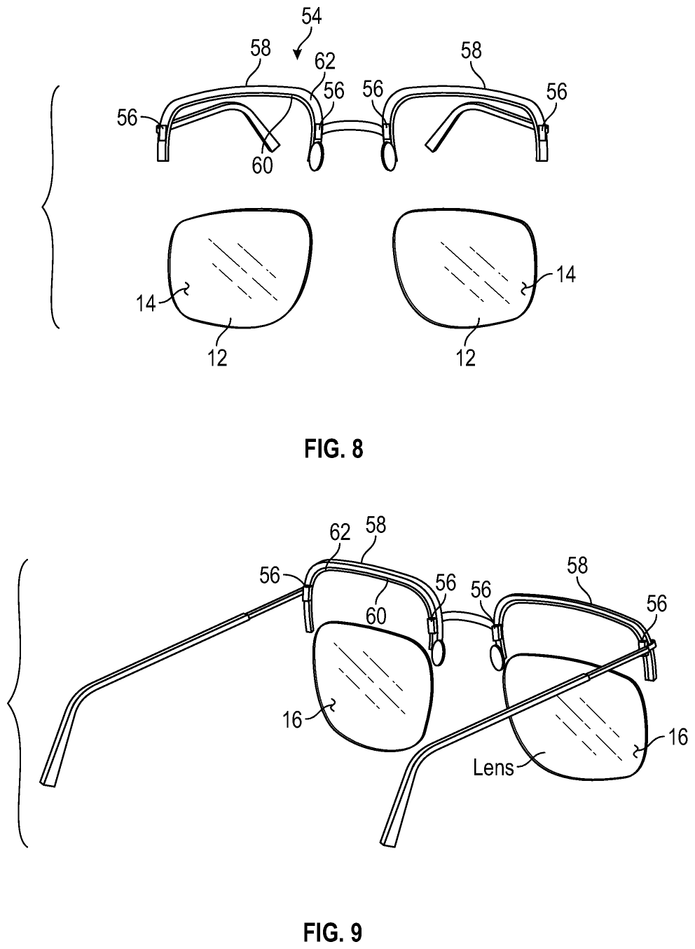

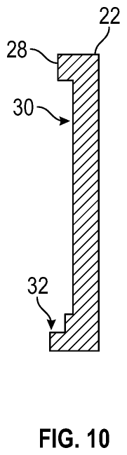

With reference now to the drawings, and in particular to FIGS. 1 through 10 thereof, a new eyeglasses device embodying the principles and concepts of an embodiment of the disclosure and generally designated by the reference numeral 10 will be described.

As best illustrated in FIGS. 1 through 10, the modular eyeglasses assembly 10 generally comprises a pair of corrective lenses 12 that is prepared to conform to a predetermined optical prescription to correct visual deficiencies for a specific user. Each of the corrective lenses 12 has a front surface 14, a back surface 16 and a perimeter edge 18 extending between the front surface 14 and the back surface 16. A pair of lens rims 15 is provided and each of the lens rims 15 is positionable around a respective one of the corrective lenses 12. Each of the lens rims 15 is continuous such that the each of the lens rims 15 forms a closed loop and each of the lens rims 15 has an interior edge 17. The interior edge 17 of each of the lens rims 15 engages the perimeter edge 18 of the respective corrective lens 12. Each of the lens rims 15 may be manufactured in a variety of different colors and each of the lens rims 15 may have alignment indicia being printed on said lens rims 15.

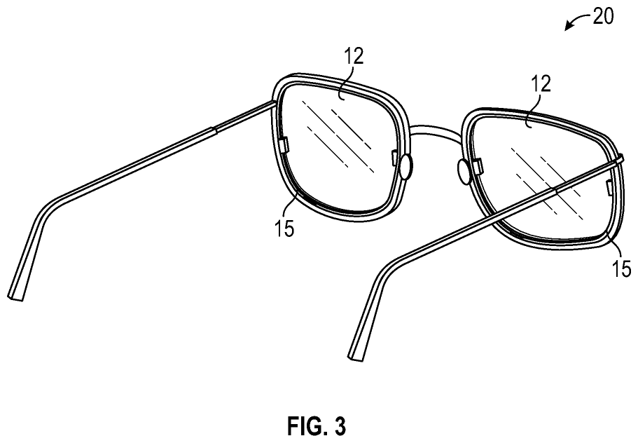

A plurality of eyeglass frames 20 is provided and each of the eyeglass frames 20 has a pair of frame rims 22. Each of the frame rims 22 has a receiving element 24 that is integrated into the frame rims 22 and the receiving element 24 in each of the frame rims 22 of a respective one of the eyeglass frames 20 releasably engages the lens rim 15 that is positioned around a respective one of the corrective lenses 12. In this way the respective eyeglass frames 20 can be worn by the specific user for correcting the specific user's vision. As is most clearly shown in FIGS. 3, 4 and 5, each of the eyeglass frames 20 has a unique structure with respect to each other. Furthermore, each of the lenses 12 is removably insertable in a respective one of the eyeglass frames 20 to facilitate the user to choose various styles of eyeglass frames 20.

Each of the frame rims 22 of each of the eyeglass frames 20 has an inwardly facing edge 26 and a rear surface 28. The inwardly facing edge 26 has a groove 30 extending around a full circumference of the inwardly facing edge 26. Additionally, the groove 30 in the inwardly facing edge 26 of each of the frame rims 22 of a respective one of the eyeglass frames 20 accommodates the lens rim 15 on a respective one of the corrective lenses 12. The inwardly facing edge 26 of each of the frame rims 22 of each of the eyeglass frames 20 has a slot 32 extending between the groove 30 and the rear surface 28 thereby facilitating the lens rim 15 on the corrective lens 12 to be engaged for removing the corrective lens 12 from the respective frame rim 22. The receiving element 24 may comprise a resiliently compressible member that extends slightly beyond the inwardly facing edge 26 of the respective frame rim 22. In this way the receiving element 24 can be compressed to facilitate the lens rim 15 to be inserted into the groove 30 and subsequently expand to retain the lens rim 15 in the groove 30.

A pair of temples 34 is provided and each of the temples 34 has a temple grip 36 that is integrated into the temple 34. The temple grip 36 on each of the temples 34 releasably engages a respective one of the corrective lenses 12 to facilitate the corrective lenses 12 to be worn by the user. Each of the temples 34 has a leading end 38 and the temple grip 36 on each of the temples 34 is positioned on the leading end 38. The temple grip 36 on each of the temples 34 comprises a pair of fingers 40 that is each perpendicularly oriented with the respective temple 34. The fingers 40 are spaced apart from each other thereby facilitating the perimeter edge 18 of the respective corrective lens 12 to be positioned between the fingers 40. Furthermore, the fingers 40 are biased together such that each of the fingers 40 compresses against a respective front surface 14 and the back surface 16 of the respective corrective lens 12.

A nose bridge 42 is provided and the nose bridge 42 has a pair of bridge grips 44 integrated into the nose bridge 42. Each of the bridge grips 44 releasably engages a respective one of the corrective lenses 12 to facilitate the corrective lenses 12 to be positioned for correcting the user's vision. In this way the temples 34 and the nose bridge 42 facilitate the corrective lenses 12 to be worn in the convention of frameless eyeglasses. The nose bridge 42 has a first end 46, a second end 48 and an outer surface 50 extending between the first end 46 and the second end 48. The nose bridge 42 is curved between the first end 46 and the second end 48 such that the nose bridge 42 forms a U-shape.

Each of the bridge grips 44 extends away from the outer surface 50 in opposite directions from each other. Each of the bridge grips 44 is spaced from a respective one of the first end 46 and the second end 48, and each of the bridge grips 44 comprises a pair of fingers 52. Each of the fingers 52 of the bridge grips 44 is spaced apart from each other thereby facilitating the perimeter edge 18 of a respective one of the corrective lenses 12 to be positioned between the fingers 52 associated with a respective one of the bridge grips 44. Furthermore, each of the fingers 52 of each of the bridge grips 44 is biased toward each other such that each of the fingers 52 of each of the bridge grips 44 compresses against a respective one of the front surface 14 and the back surface 16 of the respective corrective lens 12.

A pair of rimless eyeglass frames 54 is provided and the pair of rimless eyeglass frames 54 has a pair of receiving elements 56 each being integrated into the rimless eyeglass frames 54. Each of the receiving elements 56 in the rimless eyeglass frames 54 releasably engages a respective one of the corrective lenses 12. In this way the rimless eyeglass frames 54 can be worn by the specific user for correcting the specific user's vision. The pair of rimless eyeglass frames 54 includes a pair of lens arms 58 and each of the lens arms 58 is curved to conform to the perimeter edge 18 of a respective one of the corrective lenses 12. Each of the lens arms 58 has a bottom surface 60 and each of the lens arms 58 has a groove 62 extending into the bottom surface 60. The groove 30 in each of the lens arms 58 extends along a full length of the respective lens arm 58 such that the groove 30 in each of the lens arms 58 defines the receiving elements 56 of the rimless eyeglass frames 54. Additionally, the groove 30 in each of the lens arms 58 insertably receives the perimeter edge 18 of the respective corrective lens 12.

In use, each of the lens rims 15 is positioned around the respective corrective lenses 12. The lens rims 15 are each inserted into the groove 30 in a respective frame rim 22 of a selected pair of eyeglass frames 20, depending on the user's preference. In this way the selected eyeglass frames 20 can be worn to correct the user's vision as well as to satisfy the user's preference for the appearance of the eyeglass frames 20. A tool can be inserted into the slot 32 in each rim of the eyeglass frames 20 to remove the corrective lens 12 from the selected eyeglass frame 20. Each of the temples 34 and the nose bridge 42 can be attached to the pair of corrective lenses 12 to facilitate the user to wear the corrective lenses 12 in the convention of frameless eyeglasses. Additionally, each of the corrective lenses 12 can be inserted into the lens arms 58 of the rimless eyeglass frames 54. In this way the user can wear the corrective lenses 12 in a variety of different ways to satisfy the user's preference for the style and ornamental appearance of their eyeglasses.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular eyeglasses assembly for facilitating corrective lenses to be installed into eyeglass frames, said assembly comprising:
a pair of corrective lenses being prepared to conform to a predetermined optical prescription wherein said pair of corrective lenses is configured to correct visual deficiencies for a specific user;
a pair of lens rims, each of said lens rims being positionable around a respective one of said corrective lenses;
a plurality of eyeglass frames, each of said eyeglass frames having a pair of frame rims, each of said frame rims having a receiving element being integrated into said frame rims, said receiving element in each of said frame rims of a respective one of said eyeglass frames releasably engaging said rim being positioned around a respective one of said corrective lenses wherein said respective eyeglass frames is configured to be worn by the specific user for correcting the specific user's vision, each of said eyeglass frames having a unique structure with respect to each other, each of said lenses being removably insertable in a respective one of said eyeglass frames wherein said plurality of eyeglass frames is configured to facilitate the user to choose various styles of eyeglass frames;
a pair of temples, each of said temples having a temple grip being integrated into said temple, said temple grip on each of said temples releasably engaging a respective one of said corrective lenses wherein each of said temples is configured to facilitate said corrective lenses to be worn by the user;
a nose bridge having a pair of bridge grips being integrated into said nose bridge, each of said bridge grips releasably engaging a respective one of said corrective lenses wherein said nose bridge is configured to facilitate said corrective lenses to be positioned for correcting the user's vision; and
a pair of rimless eyeglass frames, said pair of rimless eyeglass frames having a pair of receiving elements each being integrated into said rimless eyeglass frames, each of said receiving elements in said rimless eyeglass frames releasably engaging a respective one of said corrective lenses wherein said rimless eyeglass frames is configured to be worn by the specific user for correcting the specific user's vision.

2. The assembly according to claim 1, wherein:
each of said corrective lenses having a front surface, a back surface and a perimeter edge extending between said front surface and said back surface; and
each of said frame rims of each of said eyeglass frames has an inwardly facing edge and a rear surface, said inwardly facing edge having a groove extending around a full circumference of said inwardly facing edge, said groove in said inwardly facing edge of each of said frame rims of a respective one of said eyeglass frames accommodating said lens rim being positioned around a respective one of said corrective lenses.

3. The assembly according to claim 2, wherein said inwardly facing edge of each of said frame rims of each of said eyeglass frames has a slot extending between said groove and said rear surface thereby facilitating said perimeter edge of said corrective lens to be engaged for removing said corrective lens from said respective rim.

4. The assembly according to claim 1, wherein each of said temples has a leading end, said temple grip on each of said temples being positioned on said leading end, said temple grip on each of said temples comprising a pair of fingers each being perpendicularly oriented with said respective temple, said fingers being spaced apart from each other thereby facilitating said perimeter edge of said respective corrective lens to be positioned between said fingers, said fingers being biased together such that each of said fingers compresses against a receptive front surface and said back surface of said respective corrective lens.

5. The assembly according to claim 1, wherein said nose bridge has a first end, a second end and an outer surface extending between said first end and said second end, said nose bridge being curved between said first end and said second end such that said nose bridge forms a U-shape, each of said bridge grips extending away from said outer surface in opposite directions from each other, each of said bridge grips being spaced from a respective one of said first end and said second end.

6. The assembly according to claim 5, wherein:
each of said corrective lenses having a front surface, a back surface and a perimeter edge extending between said front surface and said back surface; and
each of said bridge grips comprises a pair of fingers, each of said fingers of said bridge grips being spaced apart from each other thereby facilitating said perimeter edge of a respective one of said corrective lenses to be positioned between said fingers associated with a respective one of said bridge grips, each of said fingers of each of said bridge grips being biased toward each other such that each of said fingers of each of said bridge grips compresses against a respective one of said front surface and said back surface of said respective corrective lens.

7. The assembly according to claim 1, wherein:
each of said corrective lenses having a front surface, a back surface and a perimeter edge extending between said front surface and said back surface; and
said pair of rimless eyeglass frames including a pair of lens arms, each of said lens arms being curved to conform to said perimeter edge of a respective one of said corrective lenses, each of said lens arms having a bottom surface, each of said lens arms having a groove extending into said bottom said surface, said groove in each of said lens arms extending along a full length of said respective lens arm, said groove in each of said lens arms insertably receiving said perimeter edge of said respective corrective lens.

8. A modular eyeglasses assembly for facilitating corrective lenses to be installed into eyeglass frames, said assembly comprising:
a pair of corrective lenses being prepared to conform to a predetermined optical prescription wherein said pair of corrective lenses is configure to correct visual deficiencies for a specific user, each of said corrective lenses having a front surface, a back surface and a perimeter edge extending between said front surface and said back surface;
a pair of lens rims, each of said lens rims being positionable around a respective one of said corrective lenses, each of said lens rims being continuous such that said each of said lens rims forms a closed loop, each of said lens rims having an interior edge, said interior each of each of said lens rims engaging said perimeter edge of said respective corrective lens;
a plurality of eyeglass frames, each of said eyeglass frames having a pair of frame rims, each of said frame rims having a receiving element being integrated into said frame rims, said receiving element in each of said frame rims of a respective one of said eyeglass frames releasably engaging said lens rim being positioned around a respective one of said corrective lenses wherein said respective eyeglass frames is configured to be worn by the specific user for correcting the specific user's vision, each of said eyeglass frames having a unique structure with respect to each other, each of said lenses being removably insertable in a respective one of said eyeglass frames wherein said plurality of eyeglass frames is configured to facilitate the user to choose various styles of eyeglass frames, each of said frame rims of each of said eyeglass frames having an inwardly facing edge and a rear surface, said inwardly facing edge having a groove extending around a full circumference of said inwardly facing edge, said groove in said inwardly facing edge of each of said frame rims of a respective one of said eyeglass frames accommodating said lens rim being positioned around a respective one of said corrective lenses, said inwardly facing edge of each of said frame rims of each of said eyeglass frames having a slot extending between said groove and said rear surface thereby facilitating said lens rim positioned around said corrective lens to be engaged for removing said corrective lens from said respective frame rim, each of said receiving elements being positioned on said rear surface a respective one of said frame firms, each of said receiving elements releasably engaging said lens rim positioned around said respective corrective lens;
a pair of temples, each of said temples having a temple grip being integrated into said temple, said temple grip on each of said temples releasably engaging a respective one of said corrective lenses wherein each of said temples is configured to facilitate said corrective lenses to be worn by the user, each of said temples having a leading end, said temple grip on each of said temples being positioned on said leading end, said temple grip on each of said temples comprising a pair of fingers each being perpendicularly oriented with said respective temple, said fingers being spaced apart from each other thereby facilitating said perimeter edge of said respective corrective lens to be positioned between said fingers, said fingers being biased together such that each of said fingers compresses against a receptive front surface and said back surface of said respective corrective lens;
a nose bridge having a pair of bridge grips being integrated into said nose bridge, each of said bridge grips releasably engaging a respective one of said corrective lenses wherein said nose bridge is configured to facilitate said corrective lenses to be positioned for correcting the user's vision, said nose bridge having a first end, a second end and an outer surface extending between said first end and said second end, said nose bridge being curved between said first end and said second end such that said nose bridge forms a U-shape, each of said bridge grips extending away from said outer surface in opposite directions from each other, each of said bridge grips being spaced from a respective one of said first end and said second end, each of said bridge grips comprising a pair of fingers, each of said fingers of said bridge grips being spaced apart from each other thereby facilitating said perimeter edge of a respective one of said corrective lenses to be positioned between said fingers associated with a respective one of said bridge grips, each of said fingers of each of said bridge grips being biased toward each other such that each of said fingers of each of said bridge grips compresses against a respective one of said front surface and said back surface of said respective corrective lens; and
a pair of rimless eyeglass frames, said pair of rimless eyeglass frames having a pair of receiving elements each being integrated into said rimless eyeglass frames, each of said receiving elements in said rimless eyeglass frames releasably engaging a respective one of said corrective lenses wherein said rimless eyeglass frames is configured to be worn by the specific user for correcting the specific user's vision, said pair of rimless eyeglass frames including a pair of lens arms, each of said lens arms being curved to conform to said perimeter edge of a respective one of said corrective lenses, each of said lens arms having a bottom surface, each of said lens arms having a groove extending into said bottom said surface, said groove in each of said lens arms extending along a full length of said respective lens arm, said groove in each of said lens arms insertably receiving said perimeter edge of said respective corrective lens.
